(19) United States
(12) Patent Application Publication
(10) Pub. No.: US 2023/0191476 A1
(43) Pub. Date: Jun. 22, 2023

(54) REAL-TIME MONITORING METHOD AND STABILITY ANALYSIS METHOD FOR CONTINUOUS CASTING PROCESS

(71) Applicant: Aktiebolaget SKF, Göteborg (SE)

(72) Inventors: Gang CHENG, Shanghai (CN); Jiakai LIU, Shanghai (CN)

(21) Appl. No.: 17/990,663

(22) Filed: Nov. 19, 2022

(30) Foreign Application Priority Data
Dec. 20, 2021 (CN) 202111562620.0

(51) Int. Cl. B22D 11/16

(52) U.S. Cl. CPC B22D 11/16

(57) ABSTRACT

A real-time monitoring method for continuous casting process and a stability analysis method for continuous casting process includes several sub-processes divided according to the process sequence of the continuous casting process. The real-time monitoring method includes: determining the current sub-process of continuous casting process according slab length data and slab speed data, performing an abnormality diagnosis on the real-time data of key parameters corresponding to the current sub-process, and generating abnormality diagnosis results corresponding to the current sub-process. The stability analysis method provides: dividing actual data of key parameters into data segments corresponding to a plurality of sub-processes, inputting the actual data of key parameters belonging to the corresponding data segments into a stability feature model, outputting a stability feature index, performing abnormality diagnosis on the stability feature index, and generating an abnormality diagnosis result corresponding to the corresponding sub-process based on the output of the abnormality diagnosis.

### CROSS-REFERENCE TO RELATED APPLICATIONS

This application claims priority to Chinese Patent Application no. 202111562620.0, filed Dec. 20, 2021, the contents of which is fully incorporated herein by reference.

### TECHNICAL FIELD

The invention relates to a real-time monitoring method for continuous casting and a stability analysis method for continuous casting.

### BACKGROUND

Continuous casting process is one of the key production processes in metallurgical industry. However, so far, there is no typical and mature monitoring solution for this process and key apparatus thereof. This also leads to frequent maintenance for the whole continuous casting process and low utility and low efficiency of the apparatus. At the same time, it is difficult to detect the early process anomalies in the continuous casting process, and these process anomalies often cause large load and high temperature to the continuous casting roll of the caster, which may eventually lead to the failure of the continuous casting roll (especially the frequent failure of the bearings of key components). Especially, there is no corresponding condition detection solution for the continuous casting roll and its drive chain in the continuous caster, and it is impossible to effectively monitor and predict the life of the continuous casting roll and its drive chain.

However, in the process of continuous casting, the dangerous environment and unstable working conditions make the traditional CoMo solution (a simple vibration and temperature monitoring) insufficient or unable to effectively monitor the continuous casting process.

As mentioned above, since there is no suitable monitoring solution for continuous casting process, in the current production process, manual spot check of quality and excessive preventive maintenance are usually used to monitor the continuous casting process and key apparatus.

Specifically, the manual spot check of slab quality has the following defects: in the continuous casting process, one generally can't approach the hot slab area at high temperature, and one can't directly observe the key components of the apparatus. Therefore, it is often to monitor the slab after it is discharged from the last processing step. By finding out whether there are quality problems and the type of the quality problems have occurred in the slab after it is discharged, one can check which apparatus or component is defective. This way of deducing the abnormality of apparatus and component after manual spot check is inevitably hysteretic. Obviously, this method can't find problems in real time, let alone provide early warning to related problems, and it often brings corresponding losses to steel enterprises.

In addition, the way of excessive preventive maintenance has the following defects: during the downtime of the continuous casting apparatus, spot check personnel will generally be arranged to quickly and simply check the health status of apparatus and components, and according to his experience and related standards, it will be determined whether the corresponding components need to be replaced off-line. Because of the continuity of continuous casting production and the need for high synchronic cooperation between the upstream and downstream processes, unplanned downtime of continuous casting production is extremely undesirable in steel enterprises. In order to keep the continuous casting production going as far as possible, for those apparatus or components that can be continuously used for one or more cycles, spot check personnel cannot make a proper judgment without the support of specific data, experience and algorithms. Therefore, it tends to conservatively plan the downtime period, make plan for the apparatus and components that are difficult to be determined to go through an off-line maintenance, and replace them with those in good condition. This kind of excessive preventive maintenance often leads to the underutilization of apparatus and components (that is, the apparatus's capacity is not fully explored), which to some extent leads to the waste of apparatus's capacity, causing losses to enterprises.

### SUMMARY

In view of this, the present invention proposes a real-time monitoring method for continuous casting process, wherein the continuous casting process comprises a plurality of sub-processes divided according to the process sequence of the continuous casting process, and the real-time monitoring method comprises: acquiring actual data of key parameters related to a key apparatus among a plurality of continuous casting apparatus from a process control system for continuous casting and/or a data acquisition system for the plurality of continuous casting apparatus; receiving actual slab length data and actual slab speed data from the process control system in real time, and determining the current sub-process of the continuous casting process according to the actual slab length data and the actual slab speed data; in the current sub-process, performing an abnormality diagnosis on the real-time data of the key parameters of the key apparatus corresponding to the current sub-process, and generating an abnormality diagnosis result corresponding to the current sub-process based on the output of the abnormality diagnosis.

The invention also provides a stability analysis method for continuous casting process,

wherein the continuous casting process comprises a plurality of sub-processes divided according to the process sequence of the continuous casting process, and the stability analysis method comprises: dividing actual data of key parameters related to key apparatus among a plurality of continuous casting apparatus into a plurality of data segments respectively corresponding to the plurality of sub-processes, wherein the actual data is obtained from a process control system for the continuous casting and/or a data acquisition system for the plurality of continuous casting apparatus during the continuous casting process; inputting actual data of at least two key parameters belonging to the corresponding data segments into a stability feature model which outputs a stability feature index, wherein the stability feature model is predefined according to the correlation between the at least two key parameters; performing an abnormality diagnosis for the output stability feature index, and generating an abnormality diagnosis result corresponding to the corresponding sub-process based on the output of the abnormality diagnosis.

According to the real-time monitoring method and the stability analysis method of the present invention for the continuous casting process, the real-time monitoring of related key apparatus in respective sub-process of the continuous casting process can be realized, and the failure tendency can be predicted in advance. These two methods are suitable for different casting processes of various grades of steel, and can greatly improve the operation stability and consistency of continuous casting process, and ensure quality of the slab.

### DRAWINGS

At least one of the embodiments of the present invention is accurately represented by this application's drawings which are relied on to illustrate such embodiment(s) to scale and the drawings are relied on to illustrate the relative size, proportions, and positioning of the individual components of the present invention accurately relative to each other and relative to the overall embodiment(s). Those of ordinary skill in the art will appreciate from this disclosure that the present invention is not limited to the scaled drawings and that the illustrated proportions, scale, and relative positioning can be varied without departing from the scope of the present invention as set forth in the broadest descriptions set forth in any portion of the originally filed specification and/or drawings.

FIG. 1 is a schematic diagram showing a continuous casting system of the present invention;

FIG. 2 is a schematic diagram showing a typical continuous casting process;

FIG. 3 is a schematic diagram showing division of sub-processes for the typical continuous casting process shown in FIG. 2;

FIG. 4 is a schematic diagram showing the abnormality detection results obtained by implementing the real-time monitoring method for a reducer deemed as a key apparatus;

FIG. 5 is a schematic diagram showing the failure tendency prediction obtained by performing the stability analysis method for a continuous casting roll deemed as a key apparatus;

FIG. 6 is a flowchart showing a method integrating the two abnormality detection principles of the present invention according to a preferable embodiment of the present invention.

### DETAILED EMBODIMENTS

Those of ordinary skill in the art will appreciate from this disclosure that when a range is provided such as (for example) an angle/distance/number/weight/volume/spacing being between one (1 of the appropriate unit) and ten (10 of the appropriate units) that specific support is provided by the specification to identify any number within the range as being disclosed for use with a preferred embodiment. For example, the recitation of a percentage of copper between one percent (1%) and twenty percent (20%) provides specific support for a preferred embodiment having two point three percent (2.3%) copper even if not separately listed herein and thus provides support for claiming a preferred embodiment having two point three percent (2.3%) copper. By way of an additional example, a recitation in the claims and/or in portions of an element moving along an arcuate path by at least twenty (20°) degrees, provides specific literal support for any angle greater than twenty (20°) degrees, such as twenty-three (23°) degrees, thirty (30°) degrees, thirty-three-point five (33.5°) degrees, forty-five (45°) degrees, fifty-two (52°) degrees, or the like and thus provides support for claiming a preferred embodiment with the element moving along the arcuate path thirty-three-point five (33.5°) degrees. There are many types of rotating apparatus used in continuous casting process. For example, a whole continuous casting system includes continuous casting rolls for rolling the slab, a driving motor(s) and a reducer(s) for driving the continuous casting rolls, a cooling system for cooling slab, etc. All machines and components work in a predetermined order. The continuous casting rolls work at certain pressure and rotation speed, and a continuous casting roll is composed of a plurality of bearings and shafts, and the bearings play a major role in supporting and rotating. According to the processing stage and status of the slab, continuous casting process usually includes some different sub-processes. Accordingly, the continuous casting apparatus is also considered to be composed of a plurality of working sections, and each section has independent key apparatus to realize the corresponding processing and operation. In the actual continuous casting process, the process parameters of each section are set according to the process requirements, which usually have good consistency. For example, the total pressure of the continuous casting rolls is a linear combination of respective sub-pressures. For example, the slab temperature control of each process section is also controlled by the flow rate of cooling water of each section, which is directly associated with the slab speed.

In order to know the abnormality and stability of continuous casting process, it is usually necessary to monitor, analyze and process various process parameters. For example, for different sections, slab vibration, slab temperature, and load pressure on slab are the key parameters that affect the continuous casting process and the slab quality, and these parameters often reflect the health status of the key apparatus.

Therefore, according to the characteristics of continuous casting process and the correlation between key parameters of the key apparatus in different sub-processes, the invention provides a real-time monitoring method and a stability analysis method for the continuous casting process.

The above method of the present invention is based on the continuous casting system as shown in FIG. 1. The continuous casting system mainly includes a process control system for continuous casting and/or a data acquisition system for a plurality of continuous casting apparatus. For example, the process control system used in continuous casting is used to set and obtain the process parameters for the related apparatus in continuous casting process, such as the temperature of cooling water, the slab length, the slab speed, the electric current of the driving motor and the rotational speed of the continuous casting rolls. The process control system is, for example, any suitable process control system, such as a process control system based on PLC, iba, etc. The data acquisition system is, for example, a data acquisition system composed of any suitable sensors installed on key apparatus, including but not limited to the sensors installed on the driving motors, reducers, bearings, etc. of respective sections, especially the vibration sensors used to collect vibration data. Therefore, various data from the process control system and the data acquisition system can be used to implement the methods provided by the invention.

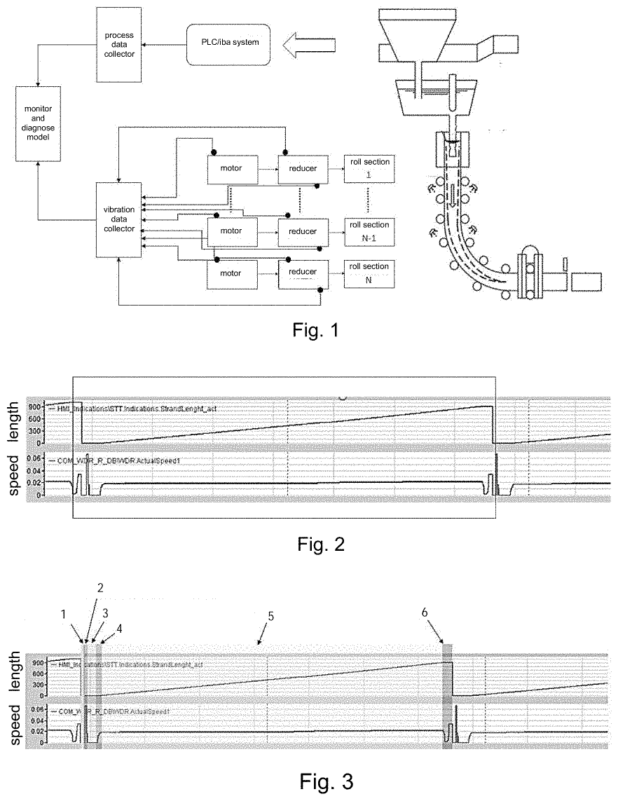

Firstly, in order to implement the methods of the invention, the continuous casting process is divided into a plurality of sub-processes according to the typical data of the slab speed and the slab length in the continuous casting process. FIG. 2 shows the corresponding relationship between the slab length (curve A) and the slab speed (curve B) in a typical continuous casting process (roughly shown by the solid line box in FIG. 2). Furthermore, according to the corresponding relationship, the continuous casting process is divided into a plurality of sub-processes as shown in FIG. 3, which includes: an initial preparation stage 1; a dummy bar head moving-back stage 2; an initial crystallization stage 3; a driving roll starting-up stage 4; a stable continuous casting stage 5; and a continuous casting ending stage 6. Therefore, the whole continuous casting process from the liquid steel pouring to the slab cutting is divided into a plurality of different sub-processes (i.e. a plurality of different stages) according to the process sequence.

According to such preferable division manner, for example, when the slab speed is 0 and the slab length is 0, it is in the “initial preparation stage 1”. When the slab length is 0 but the slab speed is very high, it is in the “dummy bar head moving-back stage 2”. When the slab length is 0 and the slab speed drops to 0 again, it is in the “initial crystallization stage 3”. When the slab length begins to increase and the slab speed begins to increase, it is in the “driving roll starting-up stage 4”. When the slab length increases at a constant rate and the slab speed keeps stable, it is in the “stable continuous casting stage 5”. When the slab length reaches the maximum and the slab speed begins to decrease (accompanied by short-term or instantaneous speed increase), it is in the “continuous casting ending stage 6”. Of course, it should be understood that the above examples are for illustration only, not for limitation. For different types of slab and their continuous casting processes, there may be different sub-process dividing standards due to their different process parameters and processes, that is, the specific values of the slab length and the slab speed used to divide the sub-process may be different.

In addition, the key apparatus associated with each sub-process has its own process parameters, which change in their normal fluctuation range. Through the above sub-process division, the operation status of the key apparatus in different sub-processes can be monitored accordingly, so as to monitor the operation status of the related key apparatus in different sub-processes, to realize more accurate real-time abnormality monitoring, and even directly determine the specific fault source.

According to a preferable embodiment of the present invention, a real-time monitoring method for continuous casting process is proposed, wherein the continuous casting process includes a plurality of sub-processes divided according to the process sequence of the continuous casting process, as described above. The monitoring method includes:

acquiring actual data of key parameters related to a key apparatus among a plurality of continuous casting apparatus from a process control system for continuous casting and/or a data acquisition system for a plurality of continuous casting apparatus;

receiving actual slab length data and actual slab speed data from the process control system in real time, and determining the current sub-process of the continuous casting process according to the actual slab length data and the actual slab speed data;

in the current sub-process, performing an abnormality diagnosis on the real-time data of the key parameters of the key apparatus corresponding to the current sub-process, and generating an abnormality diagnosis result corresponding to the current sub-process based on the output of the abnormality diagnosis.

In the above-mentioned real-time monitoring method, for different sub-processes, the associated key apparatus is different, and then the key parameters of the key apparatus are also different.

For example, for the slab rolling stages after the initial crystallization stage 3 (in particularly for the driving roll starting-up stage 4 and the stable continuous casting stage 5), the vibration of the driving motors, reducers and bearings of the continuous casting rolls, the torque on the output shaft of the reducers, the position of the continuous casting rolls and the load status on the continuous casting rolls etc. are the key parameters that reflect the slab quality as well as whether the continuous casting process is normal or not.

For example, for each sub-process, the status of the cooling water in the cooling system can reflect the process quality of the sub-process to some extent. Specifically, the cooling water temperature can usually reflect the temperature status of the slab, etc., and then reflect whether there is any abnormality in the key components such as nozzles in the cooling system. At the same time, cooling water flow rate is also an important parameter. Therefore, when necessary, the cooling water temperature and/or the cooling water flow rate can also be selected as the key parameters for the cooling system for all or individual sub-processes.

Therefore, the key apparatus and key parameters in each sub-process can be flexibly selected according to actual needs. For example, before the real-time monitoring method is implemented, it can be prescribed that, for different sub-processes, one or more of the related apparatus as the key apparatus and their key parameters should be selected, so as to directly obtain the actual values of the key parameters of the key apparatus in the continuous casting process.

In the above-mentioned real-time monitoring method, due to the difference of specific conditions in each continuous casting process, the actual sub-process may not perfectly correspond to the sub-process divided in advance according to the typical slab speed and slab length data, so it is necessary to determine the current sub-process in real time according to the actual slab length data and the actual slab speed data in each continuous casting process and according to the above-mentioned sub-process division standard, that is, to determine the accurate range of the current sub-process. The actual slab length data and the actual slab speed data can be obtained from control system for the continuous casting process, such as iba.

In order to further accurately determine the current sub-process, according to a preferable improvement of the present invention, the real-time monitoring method may further include: acquiring actual data of auxiliary parameters of one or more apparatus of the plurality of continuous casting apparatus from the process control system and/or the data acquisition system. Therefore, according to the actual data of the auxiliary parameters, the actual slab length data and the actual slab speed data, the range of the current sub-process of the continuous casting process can be more accurately determined.

Among these auxiliary parameters, the vibration of the related apparatus is usually a kind of critical auxiliary parameters, so the auxiliary parameters include, for example, the first set of auxiliary parameters, which includes one or more of the following: the vibration of the driving motor, vibration of the reducer, vibration of the bearing. According to the vibration data of the related apparatus combined with the actual slab length and the slab speed data, the sub-processes can be more accurately divided. For example, the vibration of the driving motor and/or the vibration of the reducer used in the corresponding section often corresponds to the state where the slab has traveled to this section, so it can be further confirmed that the continuous casting process has progressed to the corresponding sub-process.

Further, preferably, the auxiliary parameters may further include a second set of auxiliary parameters including one or more of the following: position of the continuous casting rolls; load status on the continuous casting rolls (usually, the load status can be 0 or 1 standing for whether there is a load or not, or it can be a specific value of the load, such as the value of the force acting on the continuous casting rolls), rotation speed of continuous casting rolls; electric current of the driving motor, torque on the output shaft of the reducer, temperature of the bearing, cooling water temperature of the cooling apparatus, cooling water flow rate of the cooling apparatus. These auxiliary parameters can be selected according to the actual needs, and the current sub-process can be further accurately determined by combining the actual slab length, the actual slab speed data and related vibration data.

For example, for the dummy bar head moving-back stage 2 and the initial crystallization stage 3, although the current sub-process can be determined according to the actual slab speed and the actual slab length in these sub-processes, the slab speed data may change drastically, while the slab length data may not change much. Therefore, by selecting the above-mentioned auxiliary parameters (such as the vibrations of the driving motor, the reducer and the bearing; the position, the rotation speed and the load status of the continuous casting rolls; the electric current of the motor; the cooling water temperature, etc.) to assist the determination of the current sub-process, so as to more accurately determine whether the corresponding sub-process has indeed started or ended.

In addition, the auxiliary parameters used to accurately determine the current sub-process are usually the key parameters of the key apparatus in the current sub-process (such as vibration data, temperature data, load data, etc. of various apparatus). Thus, according to a preferable embodiment, one or more auxiliary parameters related to the key apparatus can be selected from the first set of auxiliary parameters, to be the key parameters; and/or, one or more auxiliary parameters related to the key apparatus can be selected from the second set of auxiliary parameters, to be the key parameters, so as to perform the real-time monitoring on the key apparatus.

In the above-mentioned real-time monitoring method, various appropriate ways can be adopted to implement the abnormality diagnosis for any current sub-process. For example, a comparison result between the actual data of the key parameters of the key apparatus and the typical data of said key parameters can be obtained. The typical data of the key parameters may be values or ranges set or selected according to historical experience, and the comparison between the actual data of the key parameters and the typical data of the key parameters may include: directly comparing the actual data with the typical data, or processing the actual data (such as applying noise removal or necessary conversion, etc.) and then comparing the processed date with the typical data. Then, an abnormality diagnosis result corresponding to the current sub-process can be generated based on the comparison result.

Alternatively, the actual data of the key parameters of the key apparatus may be input into an abnormality detection model, and an abnormality diagnosis result corresponding to the current sub-process may be generated based on the output of the abnormality detection model. According to the actual needs, the abnormality detection model can be implemented as any suitable abnormality detection model, including but not limited to abnormality detection models based on isolation forest algorithm, density clustering (DBSCAN), local outlier factor (LOF) algorithm, one-class support vector machine (OneClassSVM), etc.

In addition, in a typical real-time monitoring process, the actual data of the slab length and the slab speed, and the actual data of various auxiliary parameters and/or key parameters are usually received or collected at the same time, and then the various data are synchronized (for example, according to the time stamp) with the current sub-process determined according to the above-mentioned method, and then the above-mentioned abnormality diagnosis is performed.

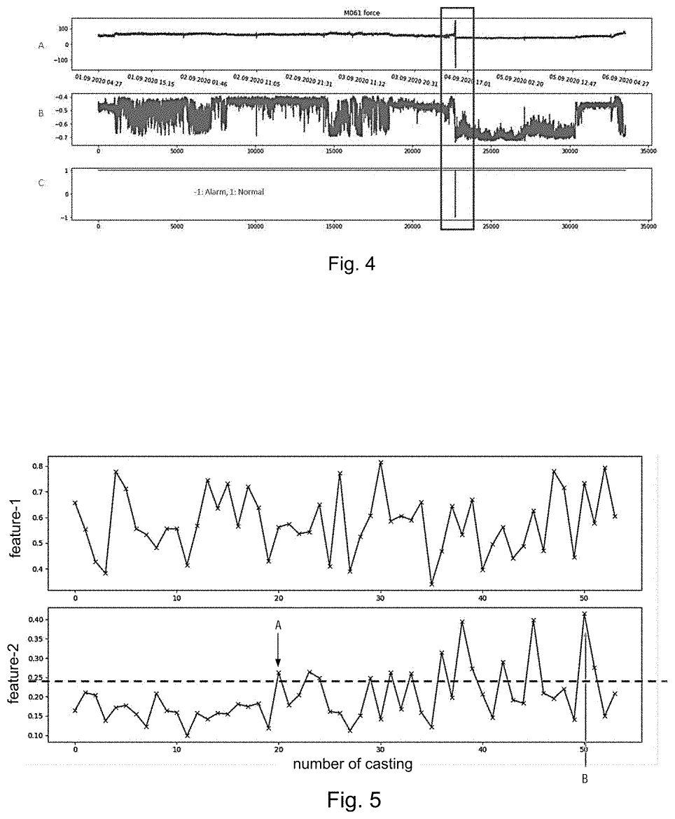

Take FIG. 4 as an example to introduce the real-time monitoring process for a related reducer in a certain sub-process. FIG. 4 shows the multiple real-time monitoring for the reducer in a certain section during a stable continuous casting stage of multiple continuous casting processes. FIG. 4 includes three plots A, B and C. In plot A, the abscissa is time, and the ordinate is the actual data of the load on the output shaft of the reducer (in kN). In plot B, the abscissa is the number of sampling points (which corresponds to the time in plot A), and the ordinate is the processed load data, which can be a value in the range of 0-1, for example. In plot C, the abscissa is the number of sampling points (which corresponds to the time in plot A), and the ordinate is the output value of alarm signal, which can be a value of 0 or 1. In the real-time detection of the multiple stable continuous casting processes, according to the detected actual load data value of the reducer (plot A) and the processed load data value (plot B), by implementing the above-mentioned real-time monitoring method, it is detected that the reducer is abnormal at the moment shown by the box in this figure, that is, the data of the force acting on the relevant output shaft obviously deviates from the normal value or range, so that an alarm signal (plot C) can be sent out in real time during this sub-process according to the abnormality detection result.

It should also be understood that, as for the real-time monitoring for different sub-processes, the above-mentioned real-time monitoring method can be performed within a predetermined time window according to the acquisition/reception frequency of the related parameters, etc.

The real-time monitoring method for continuous casting process according to the present invention has been described above, and a stability analysis method for the continuous casting process according to the present invention will be described below. Although the steps involved in the two methods above and below are described in a certain order, it should be understood that the purpose of the description is not to limit the execution order of each step, but to show that the related methods include related steps. Therefore, the execution order of various steps can be arbitrarily arranged according to the actual needs as long as the process and effect of the methods of the present invention can be realized.

According to the inventor's research, it is found that before a serious failure (such as a fault, a fracture, a shutdown, etc.) occurred in an apparatus, the operation of the apparatus had already been in an unstable status, and there was a tendency towards a serious failure. However, it is difficult to find or diagnose this tendency through conventional detection methods, and when the serious failure occurs, it often causes great losses. Therefore, the present invention proposes to realize an advanced prediction and diagnosis of the failure tendency based on stability characteristics of the key parameters of the key apparatus.

The stability analysis method according to the present invention can be performed after each continuous casting, to make tendency prediction and diagnosis based on the results obtained by the method.

For example, after completion of multiple continuous casting processes, the stability analysis can be performed on the relevant key data in each sub-process of each continuous casting process, so as to analyze the tendency of serious failure. The stability analysis method also involves division of a plurality of sub-processes according to process sequence of the continuous casting process, such as the six sub-processes described above with respect to FIG. 2. And the stability analysis method comprises the following steps:

dividing actual data of the key parameters related to the key apparatus in a plurality of continuous casting apparatus into a plurality of data segments respectively corresponding to the plurality of sub-processes, wherein the actual data is obtained from a process control system for continuous casting and/or from a data acquisition system for the plurality of continuous casting apparatus during continuous casting;

inputting actual data of at least two key parameters belonging to the corresponding data segments into a stability feature model which outputs a stability feature index, wherein the stability feature model is predefined according to the correlation between the at least two key parameters;

performing an abnormality diagnosis for the output stability feature index, and generating the abnormality diagnosis result corresponding to the corresponding sub-process based on the output of the abnormality diagnosis.

In the above-mentioned stability analysis method, as for the division of the plurality of sub-processes, a predefined sub-process division standard can be applied every time the stability analysis method is performed, or the accurate range of each sub-process in current continuous casting process can be further determined according to the above-mentioned accurate determination method based on the actual slab length data and the actual slab speed data acquired in the current continuous casting process, and then the actual data of the key parameters can be divided into said multiple data segments corresponding to the plurality of sub-processes.

The stability feature model can be preset, and at least two key parameters can be selected according to the process functions and the performance of the key apparatus in different sub-stages, to establish the stability feature model related to this sub-process, and these key parameters should have actual correlation among each other. For example, for a rolling system, the load and speed of related apparatus (such as continuous casting rolls) are highly correlated and can reflect the status of the related apparatus. For the cooling system, the temperature of the cooling water is highly correlated with the flow rate of the cooling water, and can reflect the status of related components or apparatus in the cooling system.

The following describes the stability analysis method of the present invention by taking the continuous casting rolls as an example. As mentioned above, in the process of continuous casting, the load of the continuous casting rolls is very important, and the load of the continuous casting rolls is evenly distributed to different continuous casting rolls, which is a basic process requirements. For example, the total load F_{ref} and the load on each driving roll F_{ref1} . . . F_{refn} can be defined by the following relationship:

F_{ref}=F_{ref1}+F_{ref2}+ . . . +F_{refn}

Accordingly, the load factors can be defined as below, which are calculated by the predefined load ratio:

$$\frac{{F}_{ref}}{K f} = \frac{{F}_{ref 1}}{k f 1} = \frac{{F}_{ref 2}}{k f 2} = … = \frac{{F}_{refn}}{k f n}$$

Where kf is the total load ratio, kf1 . . . kfn are the load ratios of each driving roll, which satisfy the following equation:

kf=kf1+kf2+ . . . +kfn

As the total load is also related to the casting speed in the continuous casting process, the load on each continuous casting roll is also related to the casting speed, and because of the above linear relationship, the correlation between the load on each continuous casting roll and the casting speed should be relatively stable when the system is stable, so the following two casting stability indexes can be defined based on this correlation:

std[corr(F_{ref}_{ᵢ},speed)|i=1 . . . n]

mean[corr(F_{ref}_{ᵢ},speed)|i=1 . . . n]

wherein, speed stands for the casting speed, corr(F_{ref}_{ᵢ}, speed) is the correlation function between the load and the speed, std and mean stand for variance and mean value, respectively, both of which are the stability feature indexes set for the continuous casting rolls based on the correlation between casting speed and load on the continuous casting rolls.

Preferably, according to the stability feature model defined above, the actual data of the load on the continuous casting rolls and the casting speed obtained in each continuous casting process can be input into the above model after the completion of multiple continuous casting processes, and then the stability feature index can be output. Then, an abnormality diagnosis is performed on the output stability feature index, and an abnormality diagnosis result corresponding to the corresponding sub-process is generated based on the output of the abnormality diagnosis.

Such abnormality diagnosis may include, for example, comparing the stability feature index output from the stability feature model with the historical value or threshold value of the stability feature index; or inputting the stability feature index output from the stability feature model into the abnormality detection model, and generating an abnormality diagnosis result corresponding to the corresponding sub-process based on the output of the abnormality detection model. The abnormality detection model used herein can also be any one or more of the abnormality detection models used in the above-mentioned monitoring methods, such as abnormality detection models based on isolation forest algorithm, density clustering (DBSCAN), local outlier factor (LOF) algorithm (LOF), one-class support vector machine (OneClassSVM), etc.

FIG. 5 shows the output curves of the above variance and mean value (as feature-1 and feature-2, respectively) obtained by performing multiple stability analyses after the completion of multiple continuous casting processes, where the abscissa is the number of casting and the ordinate is the value of the relevant stability feature index. In this example, it is difficult to find abnormal conditions or abnormal tendency from the curve of feature-1. However, in the curve of feature-2, according to the abnormality threshold of the stability feature index shown by the dotted line, when the index is below this threshold, the continuous casting roll is considered to be working normally; while above this threshold, for example, starting from arrow A (since about the 20th casting), the continuous casting roll may be considered to have a tendency to fail. Since the 20th casting, the number where the values of feature-2 appear above the threshold value increases, and the values thereof become larger and larger. It can be basically determined that the continuous casting roll has a risk of failure. In fact, a failure of the continuous casting roll was observed at the 50th casting indicated by arrow B. Therefore, if attention was paid to the status of the continuous casting roll after the 20th casting and necessary maintenance measures were taken in time, the failure of the continuous casting roll could be avoid in advance.

The stability feature model and analysis method for the continuous casting roll as key apparatus are given above. It should be understood that the stability analysis method of the present invention can also be applied to other key apparatus to establish corresponding stability feature models and perform effective stability analysis and diagnosis. For example, for the driving motor, a stability feature model for the driving motor can be established according to the correlation between the motor current and the rotational speed of the continuous casting roll. For the cooling system, a stability feature model for the cooling system can be established according to the correlation between the cooling water flow rate and the cooling water temperature.

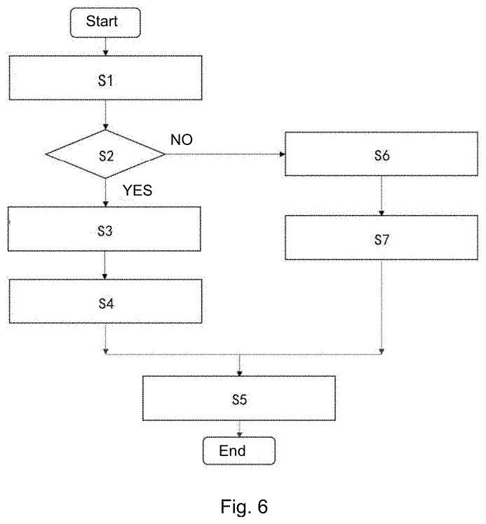

The real-time monitoring method and stability analysis method for continuous casting process according to the present invention are given above. In fact, the two methods can also be combined. FIG. 6 shows a quality monitoring method for continuous casting process according to a preferable embodiment of the present invention, which mainly includes:

at step S1, the actual slab speed, the actual slab length and related parameters of respective apparatus are acquired in real time;

at step S2, it is determined whether the current continuous casting process is completed, if so, proceeds to step S3, otherwise, proceeds to step S6; step S2 can be triggered by the execution of step S1, or by other preset conditions, for example, triggered based on preset rules of execution time.

at step S3, the stability analysis is performed based on the stability feature model established for the key parameters of the key apparatus, to obtain the relevant stability analysis index;

at step S4, abnormality diagnosis is performed for the output stability feature index;

at step S5, the current sub-process is determined according to the actual slab speed, the actual slab length and related auxiliary parameters;

at step S6, performing real-time monitoring to realize the real-time abnormality detection;

at step S7, the abnormality detection result obtained according to the real-time monitoring method and/or the stability analysis method is output, for example, output an alarm signal.

Among the above quality monitoring methods, S3-S4 correspond to the stability analysis method according to the present invention, and S6-S7 correspond to the real-time monitoring method according to the present invention.

It should be noted that the above-mentioned embodiment is only an example of preferable embodiments, and is not intended to be limiting. Corresponding modifications of the above embodiments also fall within the scope of the present invention. For example, there may be no strict performing sequence between step S1 and step S2. For example, in some embodiments, the execution of step S6 has nothing to do with the judgment result of step S2: for instance, if the judgment result of step S2 is yes, then proceed to step S3, and if the judgment result of step S2 is no, then wait until the next judgment is made. And step S6 can be triggered to execute based on the preset execution time rule, which will not be affected by the judgment result of step S2.

The real-time monitoring method and stability analysis method for continuous casting process according to the invention are described above, which can not only realize real-time monitoring of related key apparatus in each sub-process of continuous casting process, but also predict the failure tendency in advance. The two methods are suitable for different casting processes of various grades of steel, and can greatly improve the operation stability and consistency of continuous casting process, and ensure quality of the slab.

The exemplary implementation of the scheme proposed in this disclosure has been described in detail above with reference to the preferable embodiments. However, it can be understood by those skilled in the art that without departing from the concept of this disclosure, various changes and modifications can be made to the above specific embodiments, and various technical features and structures proposed in this disclosure can be combined in various ways without exceeding the scope of protection of this disclosure, which is determined by the appended claims.

1. A real-time monitoring method for continuous casting process, wherein the continuous casting process comprises a plurality of sub-processes divided according to the process sequence of the continuous casting process, and the real-time monitoring method comprises:
acquiring actual data of key parameters related to a key apparatus among a plurality of continuous casting apparatus from a process control system for continuous casting and/or a data acquisition system for the plurality of continuous casting apparatus;
receiving actual slab length data and actual slab speed data from the process control system in real time, and determining the current sub-process of the continuous casting process according to the actual slab length data and the actual slab speed data;
in the current sub-process, performing an abnormality diagnosis on the real-time data of the key parameters of the key apparatus corresponding to the current sub-process, and generating an abnormality diagnosis result corresponding to the current sub-process based on the output of the abnormality diagnosis.

2. A stability analysis method for continuous casting process, wherein the continuous casting process comprises a plurality of sub-processes divided according to the process sequence of the continuous casting process, and the stability analysis method comprises:
dividing actual data of key parameters related to key apparatus among a plurality of continuous casting apparatus into a plurality of data segments respectively corresponding to the plurality of sub-processes, wherein the actual data is obtained from a process control system for the continuous casting and/or a data acquisition system for the plurality of continuous casting apparatus during the continuous casting process;
inputting actual data of at least two key parameters belonging to the corresponding data segments into a stability feature model which outputs a stability feature index, wherein the stability feature model is predefined according to the correlation between the at least two key parameters;
performing an abnormality diagnosis for the output stability feature index, and generating an abnormality diagnosis result corresponding to the corresponding sub-process based on the output of the abnormality diagnosis.

3. The method according to claim 1, wherein the continuous casting process includes a process from molten steel pouring to slab cutting, and the sub-processes include:
initial preparation stage;
dummy bar head moving-back stage;
initial crystallization stage;
driving roll starting-up stage;
stable continuous casting stage; and
continuous casting ending stage.

4. The method according to claim 1, wherein,
the method further comprises: acquiring actual data of auxiliary parameters of one or more apparatus among the plurality of continuous casting apparatus from the process control system and/or the data acquisition system,
the step of determining the current sub-process comprises: determining the current sub-process of continuous casting process according to the actual data of the auxiliary parameters, the actual slab length data and the actual slab speed data.

5. The method according to claim 2, wherein,
the step of dividing the actual data into the plurality of data segments comprises:
dividing the actual data of key parameters related to key apparatus among the plurality of continuous casting apparatus into a plurality of data segments respectively corresponding to the plurality of sub-processes according to the actual slab length data and the actual slab speed data received from the process control system in real time, and the actual data of auxiliary parameters of one or more apparatus among the plurality of continuous casting apparatus; and/or
the abnormality diagnosis step comprises:
comparing the stability feature index output from the stability feature model with the historical value or threshold value of the stability feature index; or
inputting the stability feature index output from the stability feature model into the abnormality detection model, and generating an abnormality diagnosis result corresponding to the corresponding sub-process based on the output of the abnormality detection model.

6. The method according to claim 4, wherein the auxiliary parameters comprise a first set of auxiliary parameters, and the first set of auxiliary parameters comprises one or more of the following:
vibration of a drive motor;
vibration of a reducer;
vibration of a bearing.

7. The method of claim 6, wherein the auxiliary parameters include a second set of auxiliary parameters, and the second set of auxiliary parameters includes one or more of the following:
position of the continuous casting roll;
load status on the continuous casting roll;
rotation speed of the continuous casting roll;
electric current of the driving motor;
torque on the output shaft of the reducer;
load status on the output shaft of the reducer;
temperature of the bearing;
cooling water temperature of a cooling apparatus;
cooling water flow rate of a cooling apparatus.

8. The method of claim 7, further comprising:
selecting one or more auxiliary parameters related to the key apparatus from the first set of auxiliary parameters as the key parameters; and/or
selecting one or more auxiliary parameters related to the key apparatus from the second set of auxiliary parameters as the key parameters.

9. The method of claim 1, wherein the abnormality detection comprises:
acquiring a comparison result between the actual data of the key parameters of the key apparatus and the typical data of the key parameters, and generating an abnormality diagnosis result corresponding to the current sub-process based on the comparison result; or
inputting the actual data of the key parameters of the key apparatus into an abnormality detection model, and generating an abnormality diagnosis result corresponding to the current sub-process based on the output of the abnormality detection model.

10. The method according to claim 1 or 2, wherein the data acquisition system for a plurality of continuous casting apparatus comprises a sensor installed for the key apparatus used by at least one sub-process of the plurality of sub-processes, and the sensor is used for acquiring the actual data of the key parameters.
